(19) United States
(12) Patent Application Publication
(10) Pub. No.: US 2023/0087350 A1
(43) Pub. Date: Mar. 23, 2023

(54) THREE-PHASE MULTILEVEL ELECTRIC POWER CONVERTER

(71) Applicant: ECOLE DE TECHNOLOGIE SUPERIEURE, Montreal (CA)

(72) Inventors: Saeed ARAZM, Quebec (CA); Kamal AL-HADDAD, Montreal (CA)

(21) Appl. No.: 17/799,225

(22) PCT Filed: Feb. 15, 2021
(86) PCT No.: PCT/CA2021/050161

§ 371 Date: Aug. 11, 2022

Related U.S. Application Data
(60) Provisional application No. 62/976,952, filed on Feb. 14, 2020.

(51) Int. Cl. H02M 7/483; H02M 7/5395

(52) U.S. Cl. CPC H02M 7/4837; H02M 7/4833; H02M 7/4835; H02M 7/5395

(57) ABSTRACT

A power converter for transforming electrical power between direct current (DC) power and alternating current (AC) power is provided, as well as a controller therefor and associated methods and systems. The power converter comprises: a first set of packed U-cell converters connectable between a first common connection point and a first terminal of an external circuit, the first common connection point connecting to a first terminal of a DC circuit element; a second set of packed U-cell converters connectable between a second common connection point and a second, opposite terminal of the external circuit, the second common connection point connecting to a second, opposite terminal of the DC circuit element; and a controller configured for controlling the operation of the first and second sets of packed U-cell converters.

### TECHNICAL FIELD

The present disclosure relates generally to the field of power electronic converters, and more particularly to multilevel power converters.

### BACKGROUND

Voltage source inverters (VSIs) have become a dominant power electronics converter in various industrial applications. VSIs are used in a number of applications, including multilevel converters, which can offer improved power quality and voltage stress reduction. In particular, modular multilevel converters (MMCs) have been used in industry due to ease of repair and maintenance, since damaged modules can easily be fixed or replaced.

A traditional MMC design is composed of multiple sub-modules, which typically rely on two-level converters of various types. However, many existing MMC designs are limited in their applicability, require components having high tolerances, or produce outputs which are of limited fidelity. In some cases, achieving higher quality output waveforms requires the number of submodules in the design to be increased. This in turn can result in higher power losses, lower reliability, higher complexity in voltage balancing, increased sensors and component complexity.

As a result, improvements are needed.

### SUMMARY

In accordance with a broad aspect, there is provided a power converter for transforming electrical power between direct current (DC) power and alternating current (AC) power. The power converter comprises: a first set of packed U-cell converters connectable between a first common connection point and a first terminal of an external circuit, the first common connection point connecting to a first terminal of a DC circuit element; a second set of packed U-cell converters connectable between a second common connection point and a second, opposite terminal of the external circuit, the second common connection point connecting to a second, opposite terminal of the DC circuit element; and a controller configured for controlling the operation of the first and second sets of packed U-cell converters.

In at least some embodiments according to any one or more of the previous embodiments, the first and second sets of packed U-cell converters each comprise three packed U-cell converters, and wherein, when the external circuit is a three-phase load and the DC circuit element is a DC source, the controller is configured for controlling the operation of the first and second sets of packed U-cell converters to transform DC power produced by the DC source into AC power delivered to the three-phase load.

In at least some embodiments according to any one or more of the previous embodiments, the controller controlling the operation of the first and second sets of packed U-cell converters to transform DC power produced by the DC source into AC power delivered to the three-phase load comprises causing the first and second sets of packed U-cell converters to operate with at least one redundant state to produce the AC power, wherein the AC power has 2ⁿ + 1 phase voltage levels, where n is the number of flying capacitors in each packed U-cell converter.

In at least some embodiments according to any one or more of the previous embodiments, the controller controlling the operation of the first and second sets of packed U-cell converters to transform DC power produced by the DC source into AC power delivered to the three-phase load comprises causing the first and second sets of packed U-cell converters to operate in a plurality of non-redundant states to produce the AC power, wherein the AC power has 2⁽ⁿ⁺¹⁾―1 phase voltage levels, where n is the number flying capacitors in each packed U-cell

In at least some embodiments according to any one or more of the previous embodiments, the first and second sets of packed U-cell converters each comprise three packed U-cell converters, and wherein, when the external circuit is a three-phase AC source and the DC circuit element is a load, the controller is configured for controlling the operation of the first and second sets of packed U-cell converters to transform AC power produced by the three-phase AC source into DC power delivered to the load.

In at least some embodiments according to any one or more of the previous embodiments, each packed U-cell converter of the first and second set of packed U-cell converters comprises: a half-bridge connecting to a first terminal of the packed U-cell converter, the half-bridge comprising a first pair of switches and a first capacitor coupled therebetween; and a switching cell coupled to the half-bridge and connecting to a second terminal of the packed U-cell converter, the switching cell comprising first and second branches comprising respective first and second groups of switches, and at least one flying capacitor connecting the first and second branches.

In at least some embodiments according to any one or more of the previous embodiments, the switching cell is extendible to including a plurality of flying capacitors connecting the first and second branches, each flying capacitor coupled to the first and second branches between respective pairs of switches of the first and second groups of switches.

In at least some embodiments according to any one or more of the previous embodiments, the controller comprises: a pulse-width modulator configured for obtaining a modulation index and at least one carrier signal and for producing a plurality of voltage levels; and a voltage balancer coupled to the pulse-width modulator and configured for receiving the plurality of voltage levels and for controlling the operation of the first and second sets of packed U-cell converters based thereon

In at least some embodiments according to any one or more of the previous embodiments, the voltage balancer is further configured for controlling the operation of the first and second sets of packed U-cell converters to produce positive-polarity current across the first and second terminals of the external circuit.

In at least some embodiments according to any one or more of the previous embodiments, the first set of packed U-cell converters comprises a first collection of submodules and wherein the second set of packed U-cell converters comprises a second collection of submodules, each submodule of the first and second collections comprising a packed U-cell converter, and wherein the controller being configured for controlling the operation of the first and second sets of packed U-cell converters comprises the controller being configured for controlling operation of the first and second collections of submodules.

In at least some embodiments according to any one or more of the previous embodiments, the first and second collection of submodules each comprise a plurality of parallel branches each comprising at least one submodule arranged in series.

In at least some embodiments according to any one or more of the previous embodiments, the controller being configured for controlling the first and second collections of submodules comprises determining an amount of energy stored in capacitors of the submodules of the first and second collections of submodules and controlling the operation of the first and second collections of submodules based on the amount of energy.

In at least some embodiments according to any one or more of the previous embodiments, the controller is further configured for determining a direction of current flow through at least one of the first and the second collections of submodules, wherein controlling the operation of the first and second collections of submodules is further based on the direction of current flow.

In at least some embodiments according to any one or more of the previous embodiments, determining a direction of current flow through at least one of the first and the second collections of submodules comprises sorting the capacitors of the submodules based on a stored energy value for the capacitors.

In accordance with another broad aspect, there is provided a controller for an electrical power converter for transforming electrical power between direct current (DC) power and alternating current (AC) power. The controller comprises a pulse-width modulator and a voltage balancer coupled to the pulse-width modulator. The pulse-width modulator is configured for: obtaining a modulation index and at least one carrier signal; and producing a plurality of voltage levels based on the modulation index and the at least one carrier signal. The voltage balancer is configured for: obtaining the plurality of voltage levels from the pulse-width modulator; and controlling charging states of capacitors of first and second sets of packed U-cell converters of the electrical power converter based on the plurality of voltage level to operate the electrical power converter.

In at least some embodiments according to any one or more of the previous embodiments, the voltage balancer is further configured for controlling operation of the first and second sets of packed U-cell converters to cause the electrical power converter to produce positive-polarity current.

In at least some embodiments according to any one or more of the previous embodiments, the voltage balancer being configured for controlling the charging states of the capacitors of the first and second sets of packed U-cell converters of the electrical power converter comprises controlling the capacitors to operate with at least one redundant state.

In at least some embodiments according to any one or more of the previous embodiments, the voltage balancer being configured for controlling the charging states of the capacitors of the first and second sets of packed U-cell converters of the electrical power converter comprises controlling the capacitors to operate in a plurality of non-redundant states.

In at least some embodiments according to any one or more of the previous embodiments, the controller further comprises a plurality of sensors for measuring actual voltage levels of the capacitors of the first and second sets of packed U-cell converters of the electrical power converter.

In at least some embodiments according to any one or more of the previous embodiments, the pulse-width modulator is a phase-shift pulse-width modulator.

Features of the systems, devices, and methods described herein may be used in various combinations, in accordance with the embodiments described herein.

### BRIEF DESCRIPTION OF THE DRAWINGS

Further features and advantages of the present invention will become apparent from the following detailed description, taken in combination with the appended drawings, in which:

FIGS. 1A-B illustrate example packed U-cell converter topologies;

FIG. 2 illustrates an example three-phase converter topology connected to a three-phase load;

FIG. 3 illustrates an example grid-connected three-phase converter topology;

FIG. 4A illustrates a block diagram of an example control system for the three-phase converter topology of FIGS. 2 and/or 3;

FIG. 4B illustrates example carrier signals and reference voltage values for use by the control system of FIG. 4A;

FIGS. 5 and 6 are flowcharts for example methods of controlling the three-phase converter topology of FIGS. 2 and/or 3;

FIG. 7 illustrates an example modular three-phase converter topology;

FIG. 8 is a flowchart of an example method of controlling the modular three-phase of FIG. 7;

FIGS. 9A-C illustrate example simulation results for outputs of the converter topologies of FIGS. 2, 3, and 7.

It will be noted that throughout the appended drawings, like features are identified by like reference numerals.

### DETAILED DESCRIPTION

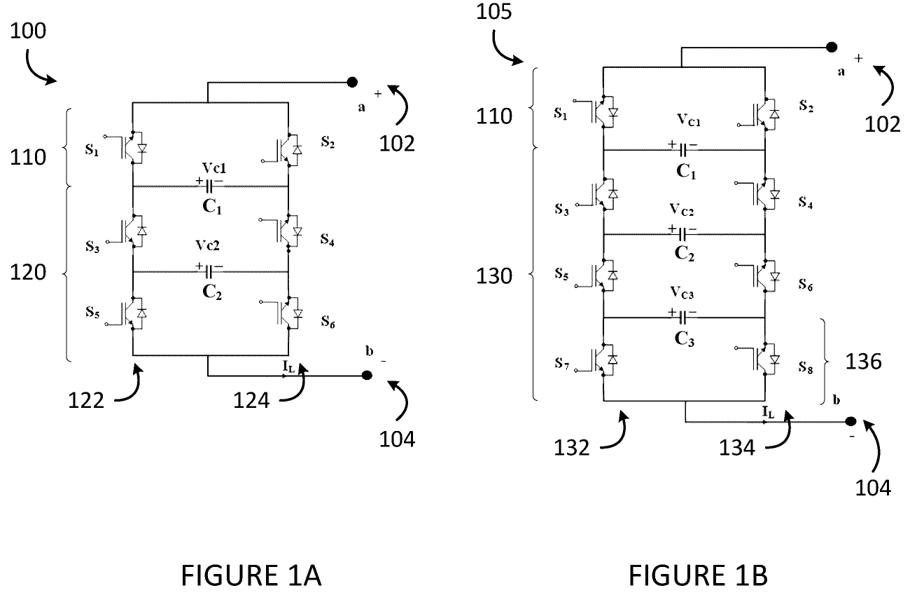

With reference to FIG. 1A, there is illustrated a voltage source inverter (VSI), termed a packed U-cell converter (PUC) 100. The PUC 100 is connectable to other circuit elements via an input terminal 102 and an output terminal 104. It should be noted that, although the terms “input terminal” and “output terminal” are used for terminals 102, 104, the PUC 100 can be configured to permit the flow of current in any suitable fashion between terminals 102, 104. As will be described in greater detail hereinbelow, the PUC 100 can be used both as a rectifier and as an inverter, and has applications in a number of power converter configurations and systems. For example, the PUC 100 can be provided with a source of direct current (DC), and be used to produce an alternating current (AC). In another example, the PUC 100 is provided with an AC source, and produces a DC output.

It should be noted that the embodiment of the PUC 100 is a variant different from what may be considered a “standard” PUC; in particular, a standard PUC may operate with one (or more) voltage sources. However, the PUC 100 illustrated in FIG. 1A is instead provided with a capacitor to replace the voltage source. In the foregoing discussion, it is considered that the various PUCs used may be similarly modified, that is to say, to replace the voltage source that may be present in a standard PUC with a capacitor. Cases where the PUCs are not varied are also considered.

The PUC 100 is composed of a half-bridge 110 and a switching cell 120. The half-bridge 110 is connected to the input terminal 102, and is composed of a pair of switches S₁ and S₂ and a capacitor C₁ coupled between the switches S₁, S₂. The input terminal 102 connects at a point intermediate the switches S₁, S₂. The switching cell 130 is composed of a pair of branches 122, 124 which both connect to the output terminal 104. The branch 122 is composed of switches S₃, S₅, and branch 124 is composed of switches S₄, S₆. A capacitor C₂ is connected between the branches 122, 124. The output terminal 104 connects at a point intermediate the switches S₅, S₆, i.e. where the branches 122, 124 connect again.

Various modes of operation for the PUC 100 are considered. In some embodiments, the PUC 100 generates 5 different voltage levels with redundant switching states. When a load is placed across the terminals 102, 104, the 5 different voltage levels can be used to produce a 9-level waveform. In some other embodiments, the PUC 100 generates 7 different voltage levels using a more complex control approach, without redundant states.

In some embodiments, switches S₁, S₂ which compose the half-bridge inverter 110 have a switching frequency less than a switching frequency of switches S₃ to S₆ of the switching cell 120. For example, the switches S₁, S₂ operate at the fundamental frequency of the alternating current to be produced by or provided to the PUC 100 (e.g., 50 Hz, 60 Hz), and the switches S₃ to S₆ operate at a frequency several orders of magnitude above the fundamental frequency (e.g., 1 kHz or more). In some embodiments, a rated voltage value for switches S₃ to S₆ of the switching cell 130 is lower than a rated voltage value for switches S₁, S₂ which compose the half-bridge inverter 110. Other embodiments are also considered.

It should also be noted that the switching cell 120 is extensible. With additional reference to FIG. 1B, an alternative embodiment of the PUC 100 is illustrated at 105. The PUC 105 is provided with a switching cell 130 having branches 132, 134. The branches 132, 134 include additional switches S₇, S₈, and the switching cell 130 includes an additional capacitor C₃. The additional switches S₇, S₈ and capacitor C₃ form an additional switching unit 136 composing the switching cell 130, and enable the PUC 105 to generate additional voltage levels. For example, the PUC 105 can generate 9 different voltage levels with redundant switching states, or 15 voltage levels with no redundancy. If a further additional switching unit 136 is added to the PUC 105, 17 different voltage levels can be generated with redundant switching states, and 31 voltage levels with no redundancy. PUCs having any suitable number of switching units 136 are considered. In general, a PUC (such as the PUCs 100 and 150) can be used to produce 2ⁿ + 1 phase voltage levels when operated with redundant states, and to produce 2ⁿ⁺¹ - 1 phase voltage levels when operated without redundant states, where n is the number of capacitors in each PUC.

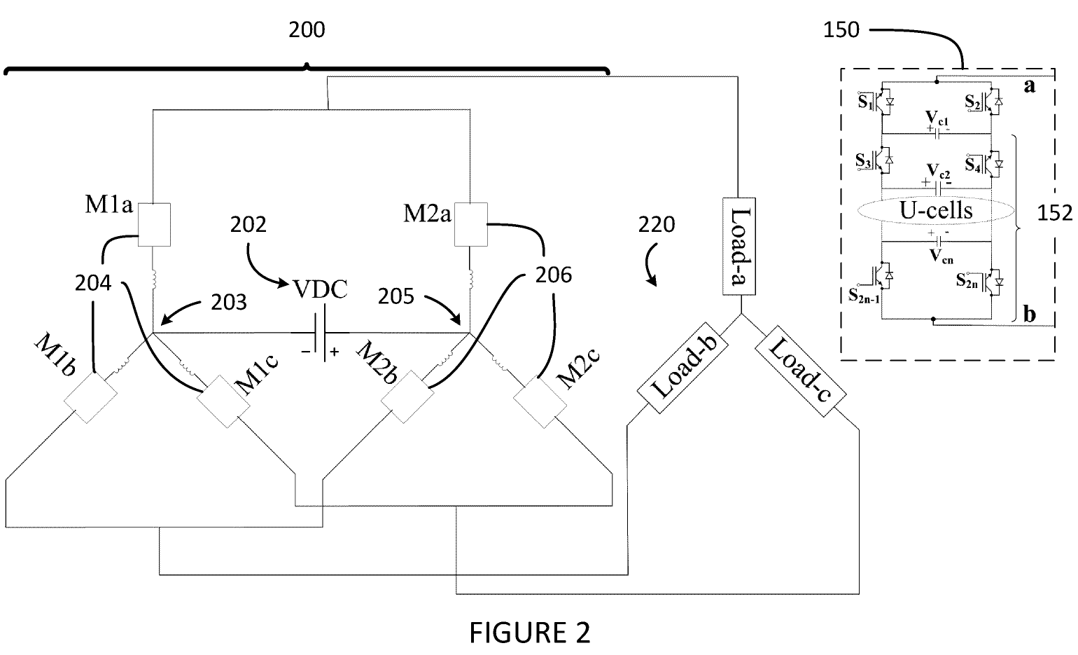

With reference to FIG. 2, a three-phase converter topology 200 (referred to herein as a “double-star topology”) is illustrated as being connected to an external circuit, for instance a three-phase load 220. The double-star topology 200 is composed of two sets of converters 204 and 206. The converters 204 and 206 can each be embodied as one of the PUCs 100, one of the PUCs 105, or as a generic PUC 150, which can have any number of switching units within a switching cell 152. Disposed between the two sets of converters is a DC circuit element, in this case a DC source 202.

The converters 204 and 206 each have two connection ports, corresponding to the ports 102, 104. The converters 204 are arranged such that one port for each of the converters 204 is coupled to a common coupling point 203 with the DC source 202, and the other port for each of the converters 204 couples to respective coupling points with one of the converters 206, and with one phase of the three-phase load 220. The converters 206 are similarly arranged, with one port for each of the converters being coupled to a common coupling point 205 with the DC source 202, and the other port for each of the converters 206 being coupled to the respective one of the converters 204 via the aforementioned coupling points.

It should be noted that the nomenclature “double-star topology” is used to describe the converter topology 200 in FIG. 2 because the arrangement of the converters 204 and 206, and their connections to the three-phase load 220, somewhat resembles a three-pointed star. This nomenclature does not imply, and should not be interpreted as implying, however, that the particular physical connections linking the converters 204 and 206 to the three-phase load 202 needs necessarily be star-shaped. Rather, any suitably-shaped connection between the converters 204 and 206 and the three-phase load 202 are considered, so long as the connections couple the aforementioned components as illustrated in FIG. 2.

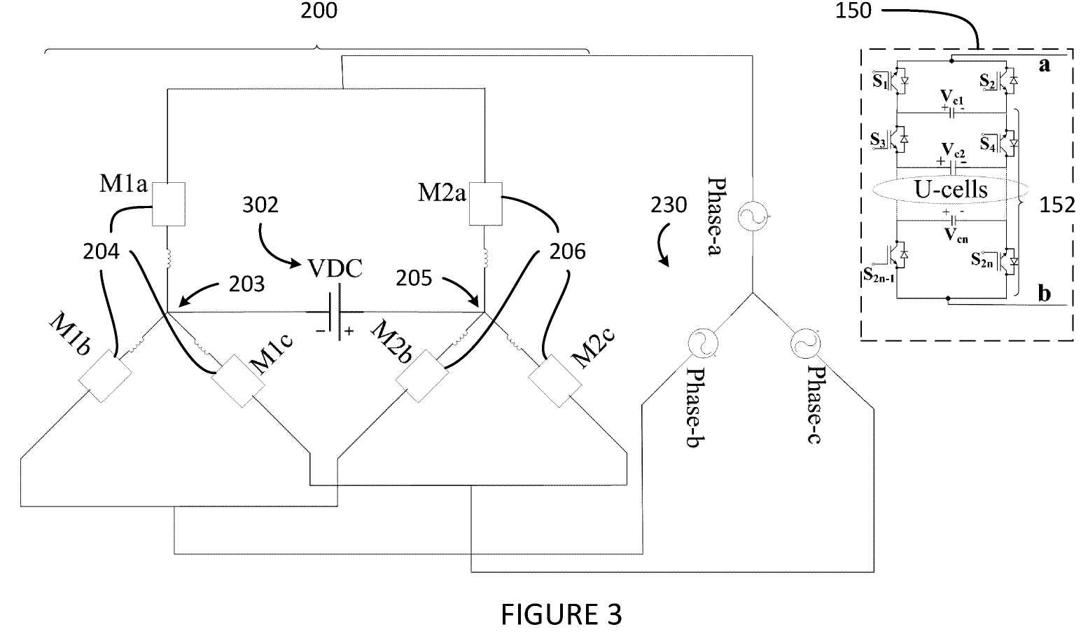

With reference to FIG. 3, the double-star topology 200 can also be used for connection to different types of external circuits, for instance a grid 230, which as illustrated in FIG. 3 is a three-phase grid, and which can be used to provide DC power to a DC circuit element (illustrated at 302). The connections between the converters 204 and 206 with the three-phase load 220 of FIG. 2 are substituted for connections to the grid 230. It should be noted that the configurations presented in FIGS. 2 and 3 are example configurations, and that others are also considered.

The converters 204, indicated as M1a, M1b, M1c, and the converters 206, indicated as M2a, M2b and M2c, form three-phase arms in two parallel branches. The converters 204 and 206 can be operated as PUC5, PUC7, PUC9, PUC15, or any other suitable PUC level, depending on the required voltage levels for each application. In some embodiments, the PUCs 100, 105, and/or 150 are modified to replace a DC source found therein with a flying capacitor.

With continued reference to FIG. 1A, Table 1 hereinbelow presents switching states for the PUC 100, Table 2 hereinbelow presents charging states for the capacitors C₁ and C₂, and Table 3 hereinbelow presents how selection of different capacitor charging states is performed.

In Table 1, if VC₁=2VC₂, the PUC 100 shown of FIGS. 1 will generate five voltage levels. If VC₁= 3VC₂, the PUC 100 produces seven voltage levels. When the PUC 100 is generating seven voltage levels, the PUC 100 does not provide any redundant states, which can complicate the control scheme for the PUC 100. The use of PUC 100 in a mode generating five voltage levels—or the use of the PUC 105 in a mode generating nine voltage levels-can reduce the need for dedicated control systems.

Table 1

| State | S1 | S3 | S5 | Output Voltage | V_{ab} if V_{C1}=2V_{C2}=2E |
|---|---|---|---|---|---|
| 1 | 1 | 0 | 0 | +V_{C1} | 2E |
| 2 | 1 | 0 | 1 | +V_{C1}-V_{C2} | E |
| 3 | 1 | 1 | 0 | +V_{C2} | E |
| 4 | 1 | 1 | 1 | 0 | 0 |
| 5 | 0 | 0 | 0 | 0 | 0 |
| 6 | 0 | 0 | 1 | -V_{C2} | -E |
| 7 | 0 | 1 | 0 | -V_{C1}+V_{C2} | -E |
| 8 | 0 | 1 | 1 | -V_{C1} | -2E |

Table II shows the relation between the current flow and charge and discharge of the flying capacitors C₁ and C₂ of the PUC 100. I_{L} is illustrated in FIG. 1A as the current leaving the output terminal 104. For instance, it is observed from the FIG. 1A that when I_{L} is positive, the capacitor C₁ is charged, and C₂ is excluded from the current flow.

Table 2

| State | I_{L}>O | | I_{L}<0 | |
|---|---|---|---|---|
| | C₁ | C₂ | C₁ | C₂ |
| 1 | ↑ | - | ↓ | - |
| 2 | ↑ | ↓ | ↓ | ↑ |
| 3 | - | ↑ | - | ↓ |
| 4 | - | - | - | - |
| 5 | - | - | - | - |
| 6 | - | ↓ | - | ↑ |
| 7 | ↓ | ↑ | ↑ | ↓ |
| 8 | ↓ | - | ↑ | - |

Table 3 is based on Table 2, in which suitable states in redundant states are selected in terms of current direction and conditions of charging and discharging of the flying capacitors C₁ and C₂. In states 1 and 8 that generate voltage +2E and -2E, there is no redundancy and consequently selections of them are inevitable. In states 4 and 5, the capacitors are excluded from the current flow, and thus no selection is required. Hence, states 2 and 3, as well as states 6 and 7, are used to generate the voltages E and -E, and thus the states to balance the voltages in C₁ and C₂. As illustrated in Table 2, for situations where I_{L}>0, C₁ is charged and C₂ is discharged during state 2; during state 3, C₂ is charged and the charge state of C₁ does not change..

Table 3

| | | |
|---|---|---|
| Condition | I_{L}>O | I_{L}<0 |
| V_{C1}> 2V_{C2} | State 3 | State 2 |
| V_{C1} <2V_{C2} | State 2 | State 3 |
| V_{C1}> 2Vc₂ | State 7 | State 6 |
| V_{C1} <2V_{C2} | State 6 | State 7 |

With continued reference to FIG. 1B, the additional switching unit 136 enables the PUC 105 to provide nine voltage levels with redundancy or fifteen (15) voltage levels without redundancy. Table 4 hereinbelow presents switching states for the PUC 150 in the nine-level configuration, in which the capacitors C₁, C₂, and C₃ are tuned such that

$${V}_{{C}_{1}} = 2 ⋅ {V}_{{C}_{2}} = 4 ⋅ {V}_{{C}_{3}} = 4 ⋅ E$$

.

Table 4

| State | S₁ | S₃ | S₅ | S₇ | V_{ab} if V_{C1}=2V_{C2}=4V_{C3}=4E |
|---|---|---|---|---|---|
| 1 | 0 | 0 | 0 | 0 | 0 |
| 2 | 0 | 0 | 0 | 1 | -V_{c3} = -E |
| 3 | 0 | 0 | 1 | 0 | -V_{c2}+V_{c3}= -E |
| 4 | 0 | 0 | 1 | 1 | -V_{c2}= -2E |
| 5 | 0 | 1 | 0 | 0 | -V_{c1}+V_{c2}= -2E |
| 6 | 0 | 1 | 0 | 1 | -V_{c1}+V_{c2}-V_{c3}= -3E |
| 7 | 0 | 1 | 1 | 0 | -Vc1+V_{c3}= -3E |
| 8 | 0 | 1 | 1 | 1 | -Vc1= -4E |
| 9 | 1 | 0 | 0 | 0 | V_{c1}=+4E |
| 10 | 1 | 0 | 0 | 1 | V_{c1}-V_{c3}= +3E |
| 11 | 1 | 0 | 1 | 0 | V_{c1}-V_{c2}+V_{c3}= +3E |
| 12 | 1 | 0 | 1 | 1 | +V_{c1} +Vc2= +2E |
| 13 | 1 | 1 | 0 | 0 | V_{c2} = +2E |
| 14 | 1 | 1 | 0 | 1 | V_{c2}-V_{c3}= +E |
| 15 | 1 | 1 | 1 | 0 | +V_{c3}= +E |
| 16 | 1 | 1 | 1 | 1 | 0 |

The difference between each module of PUC shown in FIGS. 1, 2 that is used in proposed topology and conventional one is that the capacitor C1 is replaced by DC source.

Table 5 hereinbelow presents charging states for the capacitors C₁, C₂, and C₃ of the PUC 105, and Table 6 hereinbelow presents how selection of different capacitor charging states is performed.

Table 5

| State | I_{L}<0 | | | I_{L}>O | | |
|---|---|---|---|---|---|---|
| | C₁ | C₂ | C₃ | C₁ | C₂ | C₃ |
| 1 | - | - | - | - | - | - |
| 2 | - | - | ↑ | - | - | ↓ |
| 3 | - | ↑ | ↓ | - | ↓ | ↑ |
| 4 | - | ↑ | - | - | ↓ | - |
| 5 | ↑ | ↓ | - | ↓ | ↑ | - |
| 6 | ↑ | ↓ | ↑ | ↓ | ↑ | ↓ |
| 7 | ↑ | - | ↓ | ↓ | - | ↑ |
| 8 | ↑ | - | - | ↓ | - | - |
| 9 | ↓ | - | - | ↑ | - | - |
| 10 | ↓ | - | ↑ | ↑ | - | ↓ |
| 11 | ↓ | ↑ | ↓ | ↑ | ↓ | ↑ |
| 12 | ↓ | ↑ | - | ↑ | ↓ | - |
| 13 | - | ↓ | - | - | ↑ | - |
| 14 | - | ↓ | ↑ | - | ↑ | ↓ |
| 15 | - | - | ↓ | - | - | ↑ |
| 16 | - | - | - | - | - | - |

Table 6

| | | | |
|---|---|---|---|
| Condition | I_{L}>O | I_{L}<0 | Voltage |
| V_{c2}> V_{c3} | State 3 | State 2 | -E |
| V_{c2}<V_{c3} | State 2 | State 3 | -E |
| V_{c1}> V_{c2} | State 5 | State 4 | -2E |
| V_{c1}<V_{c2} | State 4 | State 5 | -2E |
| V_{c2}> V_{c3} | State 7 | State 6 | -3E |
| V_{c2}<V_{c3} | State 6 | State 7 | -3E |
| V_{c2}> V_{c3} | State 11 | State 10 | +3E |
| V_{c2}<V_{c3} | State 10 | State 11 | +3E |
| V_{c1}> V_{c2} | State 13 | State 12 | +2E |
| V_{c1}<V_{c2} | State 12 | State 13 | +2E |
| V_{c2}> V_{c3} | State 15 | State 14 | +E |
| V_{c2}<V_{c3} | State 14 | State 15 | +E |

A voltage balancing approach for the PUC 105 of FIG. 1B, having two capacitors and a DC source, is explained in detail in “Nine-Level Packed U-Cell (PUC9) Inverter Topology with Single-DC-Source and Effective Voltage Balancing of Auxiliary Capacitors” by S. Arazm, H. Vahedi, and K. Al-Haddad, published in 2019 IEEE 28th International Symposium on Industrial Electronics (ISIE), 2019, pp. 944-949, the contents of which is hereby incorporated by reference.

Put briefly, the voltages of the capacitors C₁, C₂, and C₃ must be normalized based on E to be equal for suitable comparison. Thus, the following equations are considered:

$${v}_{{C}_{1}} = \frac{{V}_{{C}_{1}}}{4 E}$$

$${v}_{{C}_{2}} = \frac{{V}_{{C}_{2}}}{2 E}$$

$${v}_{{C}_{3}} = \frac{{V}_{{C}_{3}}}{E}$$

In equations (1) to (3), it is considered that the reference voltage for the PUCs is equal to 4E, and that the values for

$${V}_{{C}_{1}} ,$$

$${V}_{{C}_{2}} ,$$

and

$${V}_{{C}_{3}}$$

are measured via sensors in the capacitors C₁, C₂, and C₃. Referring again to Table 6, the selection of states is based on the direction of current flow within the PUC 105, and on a comparison among the normalized voltages of the capacitors C₁, C₂, and C₃. As indicated in Table 5, States 1 and 16 do not effect charging or discharging of the capacitors C₁, C₂, and C₃. Additionally, States 8 and 9, which produce a voltage level of -4E and +4E, respectively, are not redundant states. The conditions for voltage balancing in the remaining 12 states is shown in Table 6. Based on Table 6, an approach for simplifying the voltage balancing for the PUC 150, for instance for use with the double-star topology 200, can be devised. As mentioned hereinabove, the approach is described in more detail in in “Nine-Level Packed U-Cell (PUC9) Inverter Topology with Single-DC-Source and Effective Voltage Balancing of Auxiliary Capacitors”.

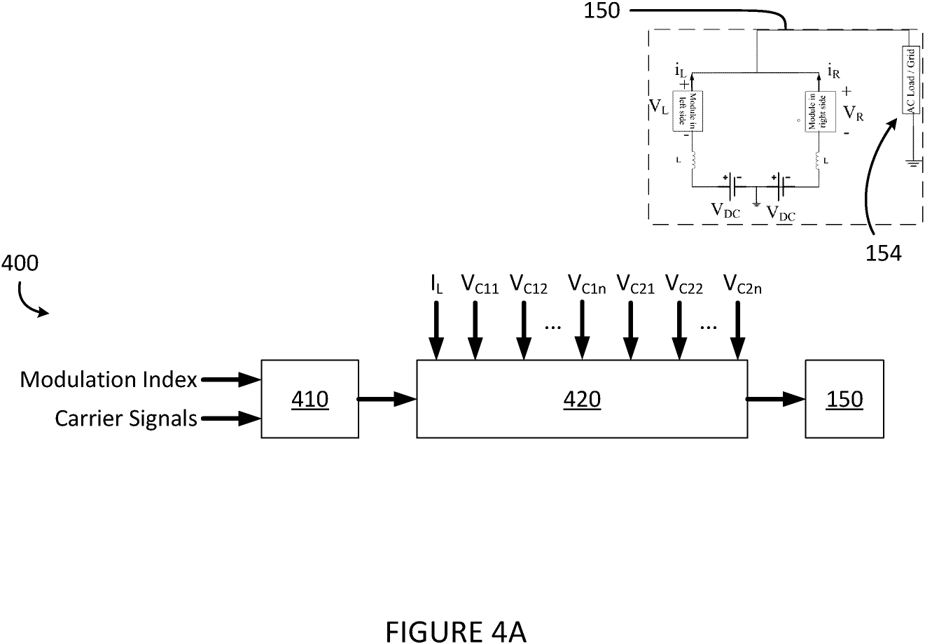

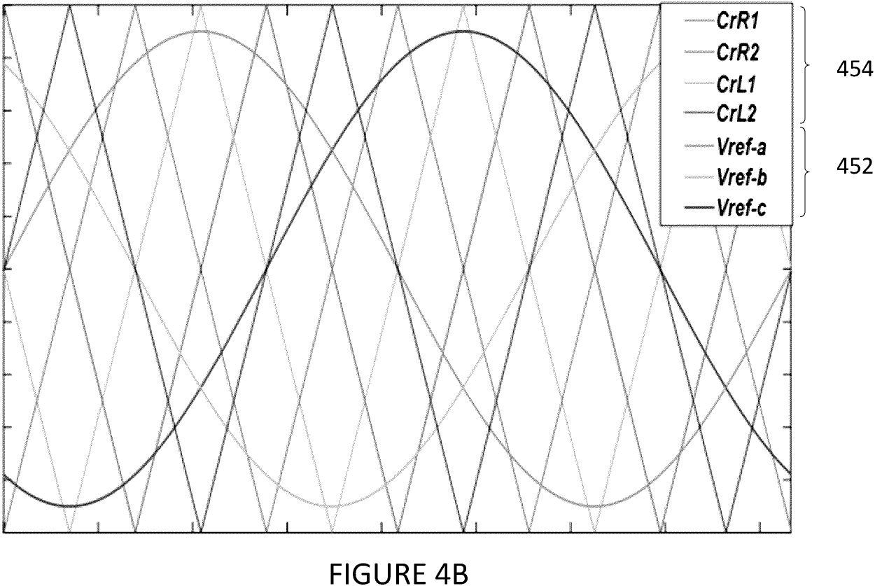

With reference to FIGS. 4, a control system 400 for the double-star topology 200 is illustrated. The control system 400 is composed of a pulse-width modulator (PWM) 410 and a voltage balancer 420. In some embodiments, the PWM 410 can be a phase-shift pulse-width modulator (PS-PWM). The PWM 410 receives a modulation index and carrier signals and generates a plurality of voltage levels indicative of the voltages to be produced by the PUCs 150 of the double-star topology 200. The voltage balancer 420 then uses the voltage levels provided by the PWM 410 and implements an algorithm, detailed in Table 6, to control the operation of the PUCs 150. It should be noted that in some other embodiments, the PS-PWM 410 can be replaced by a space-vector modulator, or by a level-shift PWM (LS-PWM).

In order to account for the three-phase nature of the double-star topology 200, additional modifications to the control system for voltage balancing of the PUCs 150 can be made. For instance, because the PUCs 150 will experience bipolar circulating current, the habitual voltage balancing approach may not allow the capacitors C₁, C₂, and C₃ to charge and discharge in the usual fashion. In some embodiments, the voltage balancing approach can be modified to restrict the use of the states presented in Table 6 to those states which generate positive-polarity current, from the perspective of the terminals 102, 104. Although this modified approach can result in a reduced number of voltage levels producible by each of the PUCs 150, it can also eliminate the need for a DC fault circuit breaker to account for those states which generate negative-polarity current.

With continued reference to FIGS. 4, the PUCs 150 can be illustrated via a single-line diagram, as shown in FIGS. 4. It should be understood that the configuration illustrated at element 150 in FIGS. 4 represents the same PUC configuration as the PUC 150 in FIGS. 2 and 3, but with simplified circuit elements to facilitate the explanation. The current provided to a load 154 comes from left and right branches of the PUC 150, and can be expressed as:

$${i}_{x} = \frac{{i}_{L +} {i}_{R}}{2}$$

where iₓ is the current to the load 154, i_{L} is the current from the left branch of the PUC 150, and i_{R} is the current from the right branch of the PUC 150. The voltage provided to the load 154, termed here V_{diff}, can be determined by

$${V}_{d i f f} = {V}_{L} - {V}_{R} - 2 {V}_{d c}$$

where V_{L} is the voltage across the left branch of the PUC 150, V_{R} is the voltage across the right branch of the PUC 150, and the voltage provided by the source is 2V_{dc}.

From equation (5), it can be deduced that, to reduce the current circulating in each states subtraction of voltages in left and right side should be equal or close to the DC link voltage. If high levels of current are permitted to circulate through the left and right branches of the PUC 150, unstable operation of the PUC 150 can occur. A switching methodology for controlling the PUC 150 in the double-star configuration 200 is shown below in Table 7.

Table 7

| State | S_{R}1 | S_{R}2 | S_{R}3 | S_{L}1 | S_{L}2 | S_{L}3 | V_{R} | V_{L} | V_{diff} | Vout (MMC) |
|---|---|---|---|---|---|---|---|---|---|---|
| 1 | 1 | 0 | 0 | 0 | 1 | 1 | 2E | -2E | -2Vdc | 2E |
| 2 | 1 | 0 | 1 | 0 | 1 | 0 | E | -E | -2Vdc | E |
| 3 | 1 | 0 | 1 | 0 | 0 | 1 | E | -E | -2Vdc | E |
| 4 | 1 | 1 | 0 | 0 | 1 | 0 | E | -E | -2Vdc | E |
| 5 | 1 | 1 | 0 | 0 | 0 | 1 | E | -E | -2Vdc | E |
| 6 | 1 | 0 | 0 | 0 | 0 | 0 | 2E | 0 | 0 | E |
| 7 | 1 | 1 | 1 | 0 | 0 | 0 | 0 | 0 | -2Vdc | 0 |
| 8 | 1 | 0 | 0 | 1 | 0 | 0 | 2E | 2E | 2Vdc | 0 |
| 9 | 1 | 0 | 1 | 1 | 0 | 1 | E | E | 0 | 0 |
| 10 | 1 | 1 | 0 | 1 | 1 | 0 | E | E | 0 | 0 |
| 11 | 1 | 0 | 1 | 1 | 1 | 0 | E | E | 0 | 0 |
| 12 | 1 | 1 | 0 | 1 | 0 | 1 | E | E | 0 | 0 |
| 13 | 0 | 1 | 0 | 0 | 1 | 0 | -E | -E | -4Vdc | 0 |
| 14 | 0 | 0 | 1 | 1 | 1 | 0 | -E | E | -2Vdc | -E |
| 15 | 0 | 0 | 1 | 1 | 0 | 1 | -E | E | -2Vdc | -E |
| 16 | 0 | 1 | 0 | 1 | 1 | 0 | -E | E | -2Vdc | -E |
| 17 | 0 | 1 | 0 | 1 | 0 | 1 | -E | E | -2Vdc | -E |
| 18 | 0 | 1 | 1 | 0 | 0 | 0 | -2E | 0 | -4Vdc | -E |
| 19 | 0 | 0 | 0 | 1 | 0 | 0 | 0 | 2E | 0 | -E |
| 20 | 0 | 1 | 1 | 1 | 0 | 0 | -2E | 2E | -2Vdc | -2E |

Table 7 shows the all output voltages produced by the PUC 150 with one module in two sides for one phase of the double-star topology 200. Of note, V_{diff} is zero in a number of states, which results in a minimum amount of current circulating through the PUC 150. With additional reference to Table 1, states 100, 101, 110, 111, 000 generate voltage +2E, +E, 0. Accordingly, it can be seen from Table 7 that V_{diff} is zero on states 6, 9, 10, 11, 12 and 19 where both left and right modules has been set on positive mentioned polarity. As a result, this modified voltage balancing approach uses those states with positive-polarity current; states with negative-polarity current are used for disconnecting the converter in DC fault short circuit current. In some embodiments, these considerations are also applied to modular PUCs.

In one example, and with reference to FIG. 4B, to generate five phase-voltage levels and nine line-voltage levels at the output of a multilevel embodiment of the PUC 150 with one DC source, three reference voltages, illustrated by sinusoidal curves 452, and four carrier signals, illustrated by zigzag lines 454, are produced to initiate the switching devices. As illustrated in FIG. 4B, the carriers CrL1 and CrL2 are related to the left side module and CrR1, CrR2 are the carriers for right side module. Reference voltages Vref-a, Vref-b and Vref-c are the modulating signals. The values presented in Tables 8, 9, and 10 indicate the switching methodology used for the PUCs 150 within the double-star topology 200, both in three-phase and when used as part of a modular converter, when the PUCs 150 correspond to the PUCs 100 of FIG. 1A. In particular, Table 8 indicates the switching states for the PUCs 100, Table 9 indicates the charging or discharging state for the capacitors, and Table 10 indicates the state selection methodology.

Table 8

| State | S1 | S3 | S5 | Output Voltage | V_{ab} if V_{C1}=2V_{C2}=2E |
|---|---|---|---|---|---|
| 1 | 1 | 0 | 0 | +V_{C1} | 2E |
| 2 | 1 | 0 | 1 | +V_{C1}-V_{C2} | E |
| 3 | 1 | 1 | 0 | +V_{C2} | E |
| 4 | 1 | 1 | 1 | 0 | 0 |
| 5 | 0 | 0 | 0 | 0 | 0 |

Table 9

| State | I_{L}>O | | I_{L}<0 | |
|---|---|---|---|---|
| | C₁ | C₂ | C₁ | C₂ |
| 1 | ↑ | - | ↓ | - |
| 2 | ↑ | ↓ | ↓ | ↑ |
| 3 | - | ↑ | - | ↓ |
| 4 | - | - | - | - |
| 5 | - | - | - | - |

Table 10

| Condition | I_{L}>O | I_{L}<0 |
|---|---|---|
| V_{C1}> 2V_{C2} | State 3 | State 2 |
| V_{C1} <2V_{C2} | State 2 | State 3 |

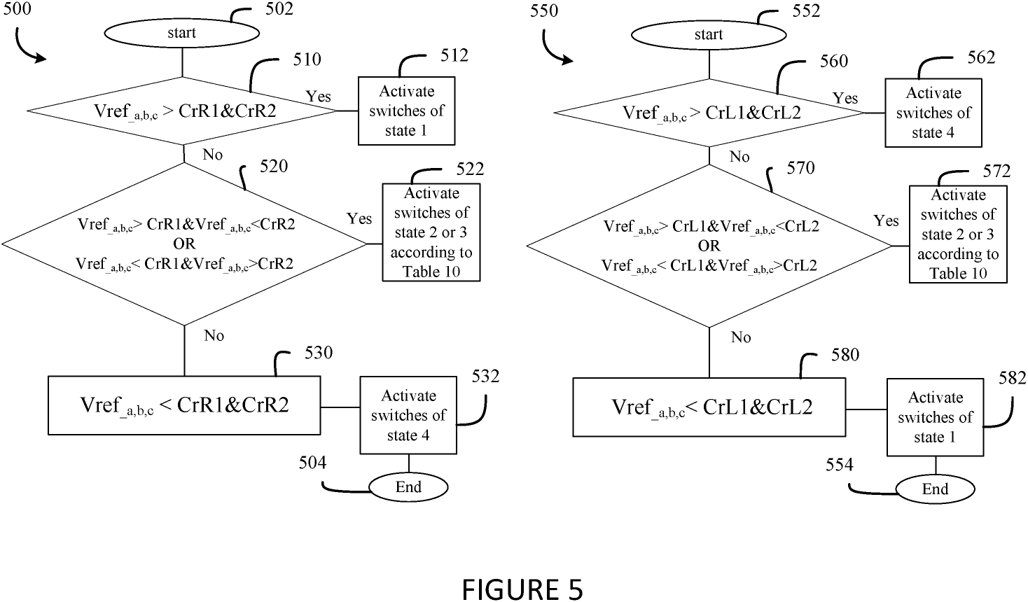

With reference to FIG. 5, methods 500 and 550 for controlling and balancing the voltage of the PUCs 150 are illustrated via flowcharts. The method 500 is used for voltage balancing for the right branch of the PUCs 150, and the method 550 is used for voltage balancing for the left branch. The methods 500 and 550 apply when the PUCs 150 correspond to PUCs 100 of FIG. 1A.

Considering first the method 500, the method starts at 502. At 510, an evaluation is made regarding whether the reference voltage

$${V}_{r e {f}_{a , b , c}}$$

is greater than the carrier voltages. If yes, the switches of state 1 (from Table 9) are activated, as per step 512. If no, the method 500 proceeds to step 520.

At step 520, an evaluation is made regarding whether the reference voltage

$${V}_{r e {f}_{\text{a,b,c}}}$$

is greater than the carrier voltage CrR1 and less than the carrier voltage CrR2, or whether the reference voltage

$${V}_{r e {f}_{\text{a,b,c}}}$$

is less than the carrier voltage CrR1 and greater than the carrier voltage CrR2. If yes, the switches of state 2 or 3 are activated, in accordance with Table 10, as per step 522. If no, the method 500 proceeds to step 530.

At step 530, an evaluation is made regarding whether the reference voltage

$${V}_{r e {f}_{\text{a,b,c}}}$$

is less than the carrier voltages. If yes, the switches of state 4 (from Table 9) are activated, as per step 532. The method then ends at step 504.

In the method 550, the method starts at 552. At 560, an evaluation is made regarding whether the reference voltage

$${V}_{r e {f}_{\text{a,b,c}}}$$

is greater than the carrier voltages. If yes, the switches of state 4 (from Table 9) are activated, as per step 562. If no, the method 550 proceeds to step 570.

At step 570, an evaluation is made regarding whether the reference voltage

$${V}_{r e {f}_{\text{a,b,c}}}$$

is greater than the carrier voltage CrL1 and less than the carrier voltage CrR2, or whether the reference voltage

$${V}_{r e {f}_{a , b , c}}$$

is less than the carrier voltage CrL1 and greater than the carrier voltage CrL2. If yes, the switches of state 2 or 3 are activated, in accordance with Table 10, as per step 572. If no, the method 500 proceeds to step 580.

At step 580, an evaluation is made regarding whether the reference voltage

$${V}_{r e {f}_{a , b , c}}$$

is less than the carrier voltages. If yes, the switches of state 1 (from Table 9) are activated, as per step 582. The method then ends at step 554.

Although, according to Table 8, each of the PUCs 150 generates three voltage levels, the control algorithm proposed in FIG. 5 produces five voltage levels at the output of each phase, and consequently nine voltage levels at the line voltage. The methods 500, 550 are based on phase shift modulation techniques.

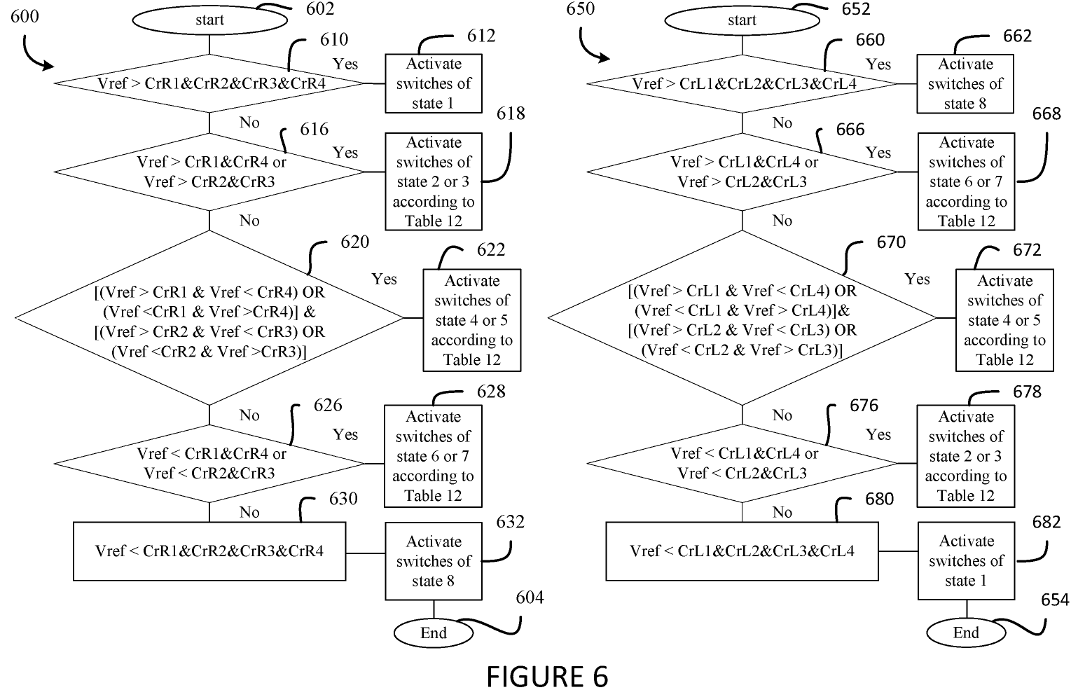

With additional reference to FIG. 6, similar methods 600 and 650 can be used for PUCs 150 which correspond to the PUCs 105 of FIG. 1B. The values presented in Tables 11, 12, and 13 indicate the switching methodology used for the PUCs 150 within the double-star topology 200, both in three-phase and when used as part of a modular converter, when the PUCs 150 correspond to the PUCs 105 of FIG. 1B. In particular, Table 11 indicates the switching states for the PUCs 105, Table 12 indicates the charging or discharging state for the capacitors, and Table 13 indicates the state selection methodology.

Table 11

| State | S₁ | S₃ | S₅ | S₇ | V_{ab} if V_{C1}=2V_{C2}=4V_{C3}=4E |
|---|---|---|---|---|---|
| 1 | 1 | 0 | 0 | 0 | V_{c1} =+4E |
| 2 | 1 | 0 | 0 | 1 | V_{c1}-V_{c3}= +3E |
| 3 | 1 | 0 | 1 | 0 | V_{c1}-V_{c2}+V_{c3}= +3E |
| 4 | 1 | 0 | 1 | 1 | +V_{c1} +V_{c2}= +2E |
| 5 | 1 | 1 | 0 | 0 | V_{c2} = +2E |
| 6 | 1 | 1 | 0 | 1 | V_{c2}-V_{c3}= +E |
| 7 | 1 | 1 | 1 | 0 | +V_{c3}= +E |
| 8 | 1 | 1 | 1 | 1 | 0 |

Table 12

| State | I_{L}<0 | | | I_{L}>O | | |
|---|---|---|---|---|---|---|
| | C₁ | C₂ | C₃ | C₁ | C₂ | C₃ |
| 1 | ↑ | - | - | ↑ | - | - |
| 2 | ↓ | - | ↑ | ↑ | - | ↓ |
| 3 | ↓ | ↑ | ↓ | ↑ | ↓ | ↑ |
| 4 | ↓ | ↑ | - | ↑ | ↓ | - |
| 5 | - | ↓ | - | - | ↑ | - |
| 6 | - | ↓ | ↑ | - | ↑ | ↓ |
| 7 | - | - | ↓ | - | - | ↑ |
| 8 | - | - | - | - | - | - |

Table 13

| | | | |
|---|---|---|---|
| Condition | I_{L}>O | I_{L}<0 | voltage |
| V_{c2}> V_{c3} | State 3 | State 2 | +3E |
| V_{c2}<V_{c3} | State 2 | State 3 | +3E |
| V_{c1}> V_{c2} | State 5 | State 4 | +2E |
| V_{c1}<V_{c2} | State 4 | State 5 | +2E |
| V_{c2}> V_{c3} | State 7 | State 7 | +E |
| V_{c2}<V_{c3} | State 6 | State 6 | +E |

Considering first the method 600, the method starts at 602. At step 610, an evaluation is made regarding whether the reference voltage

$${V}_{r e {f}_{a , b , c}}$$

is greater than the four carrier voltages. If yes, the switches of state 1 (from Table 12) are activated, as per step 612. If no, the method 600 proceeds to step 616.

At step 616, an evaluation is made regarding whether the reference voltage

$${V}_{r e {f}_{a , b , c}}$$

is greater than the carrier voltages CrR1 and CrR4, or whether the reference voltage

$${V}_{r e {f}_{a , b , c}}$$

is greater than the carrier voltages CrR2 and CrR3. If yes, the switches of state 2 or 3 are activated, in accordance with Table 12, as per step 618. If no, the method 600 proceeds to step 620.

At step 620, an evaluation is made regarding whether one of two condition sets are true. The first condition set is whether the reference voltage

$${V}_{r e {f}_{a , b , c}}$$

is greater than the carrier voltage CrR1 and less than the carrier voltage CrR4, or whether the reference voltage

$${V}_{r e {f}_{a , b , c}}$$

is less than the carrier voltage CrR1 and greater than the carrier voltage CrR4. The second condition set is whether the reference voltage

$${V}_{r e {f}_{a , b , c}}$$

is greater than the carrier voltage CrR2 and less than the carrier voltage CrR3, or whether the reference voltage

$${V}_{r e {f}_{a , b , c}}$$

is less than the carrier voltage CrR2 and greater than the carrier voltage CrR3. If either the first or second condition set is true, the switches of state 4 or 5 are activated, in accordance with Table 12, as per step 622. If no, the method 600 proceeds to step 626.

At step 626, an evaluation is made regarding whether the reference voltage

$${V}_{r e {f}_{a , b , c}}$$

is less than the carrier voltages CrR1 and CrR4, or whether the reference voltage

$${V}_{r e {f}_{\text{a,b,c}}}$$

is less than the carrier voltages CrR2 and CrR3. If yes, the switches of state 6 or 7 are activated, in accordance with Table 12, as per step 628. If no, the method 600 proceeds to step 630.

At step 630, an evaluation is made regarding whether the reference voltage

$${V}_{r e {f}_{\text{a,b,c}}}$$

is less than the four carrier voltages. If yes, the switches of state 8 (from Table 12) are activated, as per step 632. The method then ends at 604.

In the method 650, the method starts at 652. At step 660, an evaluation is made regarding whether the reference voltage

$${V}_{r e {f}_{\text{a,b,c}}}$$

is greater than the four carrier voltages. If yes, the switches of state 8 (from Table 12) are activated, as per step 662. If no, the method 650 proceeds to step 666.

At step 666, an evaluation is made regarding whether the reference voltage

$${V}_{r e {f}_{\text{a,b,c}}}$$

is greater than the carrier voltages CrL1 and CrL4, or whether the reference voltage

$${V}_{r e {f}_{\text{a,b,c}}}$$

is greater than the carrier voltages CrL2 and CrL3. If yes, the switches of state 6 or 7 are activated, in accordance with Table 12, as per step 668. If no, the method 650 proceeds to step 670.

At step 670, an evaluation is made regarding whether one of two condition sets are true. The first condition set is whether the reference voltage

$${V}_{r e {f}_{a , b , c}}$$

is greater than the carrier voltage CrL1 and less than the carrier voltage CrL4, or whether the reference voltage

$${V}_{r e {f}_{a , b , c}}$$

is less than the carrier voltage CrL1 and greater than the carrier voltage CrL4. The second condition set is whether the reference voltage

$${V}_{r e {f}_{a , b , c}}$$

is greater than the carrier voltage CrL2 and less than the carrier voltage CrL3, or whether the reference voltage

$${V}_{r e {f}_{a , b , c}}$$

is less than the carrier voltage CrL2 and greater than the carrier voltage CrL3. If either the first or second condition set is true, the switches of state 4 or 5 are activated, in accordance with Table 12, as per step 672. If no, the method 650 proceeds to step 676.

At step 676, an evaluation is made regarding whether the reference voltage

$${V}_{r e {f}_{a , b , c}}$$

is less than the carrier voltages CrL1 and CrL4, or whether the reference voltage

$${V}_{r e {f}_{\text{a,b,c}}}$$

is less than the carrier voltages CrL2 and CrL3. If yes, the switches of state 2 or 3 are activated, in accordance with Table 12, as per step 678. If no, the method 650 proceeds to step 680.

At step 680, an evaluation is made regarding whether the reference voltage

$${V}_{r e {f}_{\text{a,b,c}}}$$

is less than the four carrier voltages. If yes, the switches of state 1 (from Table 12) are activated, as per step 682. The method then ends at 654.

In some embodiments, the carrier signals which are selected for left-side PUCs 150 are phase-shifted by π/4 relative to those selected for the right-side PUCs 150. Additionally, the carrier signals can each be phase-shifted by π/2 relative to one another. It should be noted that when reference is made to a “reference voltage” in the foregoing discussion relating to the methods 500, 550, 600, and 650, this can refer to any one of the reference voltages used for any of the three phases (i.e., phases a, b, and c).

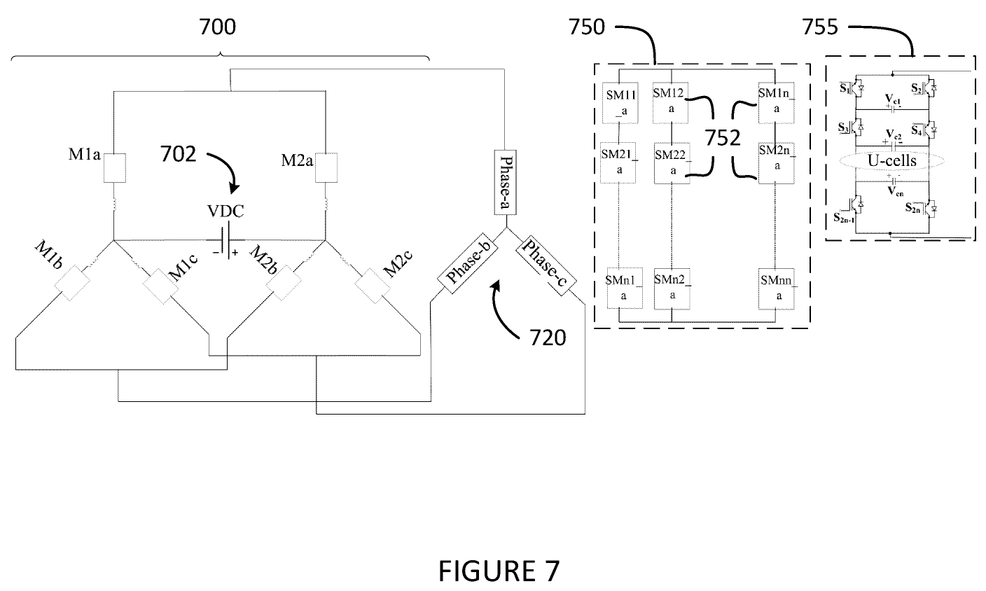

With reference to FIG. 7, a variant of the converter topology 200 is shown. The PUC-modular multilevel converter (PUC-MMC), illustrated at 700, replaces the converters 204, 206 of FIGS. 2 and 3 with a collection 750 of parallel and series submodules 752, to produce a modular version of the converter topology 200. As illustrated in FIG. 7, the converters M1a, M1b, M1c, M2a, M2b and M2c, are each provided as a collection 750 composed of the series and parallel submodules 752 from SM11 to SMnn. For instance, the collection 750 is arranged as multiple parallel branches, each comprising one or more submodules 752 arranged in series. The PUC-MMC 700 can be coupled to any suitable type of external circuit, for instance a three-phase load 720, and to any suitable type of DC circuit element, for instance a DC source 702.

These submodules 752 are replaced by a modified PUC, illustrated at 755. The PUC 755 is modified such that the DC source has been replaced by a flying capacitor. It should be noted that general model of PUC 755 that is shown in FIG. 7 can be operated as producing any suitable number of voltage levels, including as PUC5, PUC7, PUC9, PUC15, or the like. The use of the PUC 755 can, in some embodiments, result in increased voltage levels and power rating at the output.

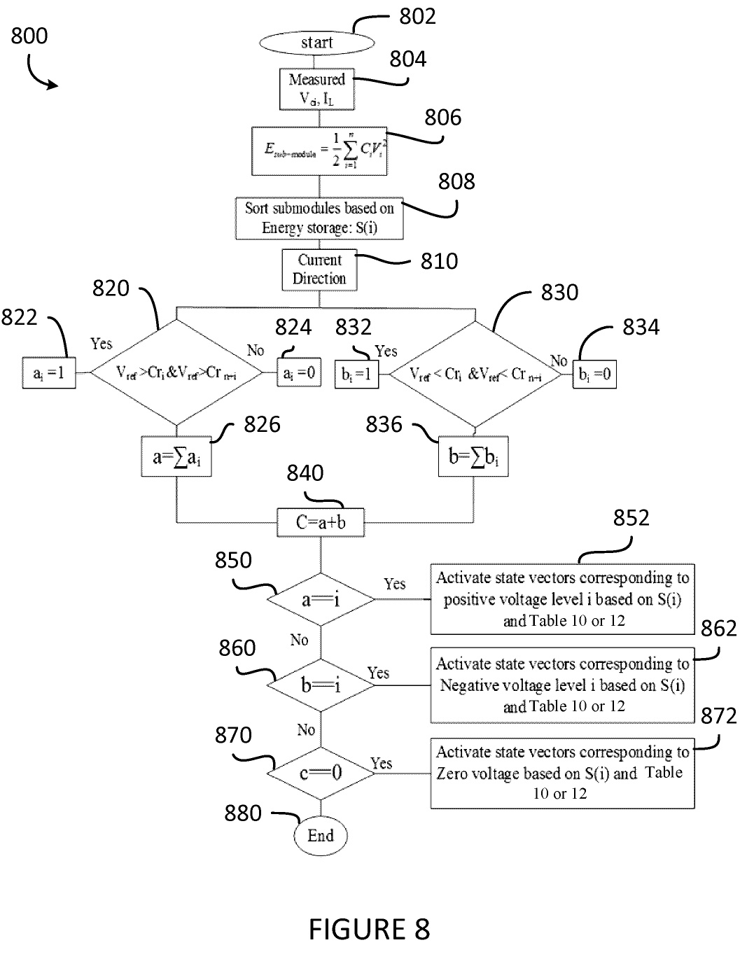

With additional reference to FIG. 8, a method 800 for performing voltage balancing with the PUC-MMC 700 is provided. The method starts at 802. At step 804, the voltage V_{ci} and the current I_{L} are measured. At step 806, the amount of energy stored in the capacitors of the PUC-MMC 700, termed E_{sub-module}, is determined via the equation

$${E}_{\text{sub-module}} = \frac{1}{2} {\sum }_{i = 1}^{n} {C}_{i} {V}_{i}^{2}$$

in which Cᵢ is the capacitance of the capacitors within the PUC-MMC 700, Vᵢ is the voltage across the capacitors within the PUC-MMC 700, and the sum is performed over the n capacitors within the PUC-MMC 700.

At step 808, the submodules 752 are sorted as a function of the amount of energy stored therein. At step 810, the direction of the current flowing through the collection 750 is ascertained.

At step 820, an evaluation is made regarding whether the reference voltage V_{ref} is greater than the i^{th} carrier voltage, and whether V_{ref} is greater than the (n + i)^{th} carrier voltage. If yes, the method 800 proceeds to step 822, and the i^{th} variable aᵢ is set to ‘1’. If no, the method 800 proceeds to step 824, and the i^{th} variable aᵢ is set to ‘0’. At step 826, the sum of all variables aᵢ are summed as a.

At step 830, an evaluation is made regarding whether the reference voltage V_{ref} is less than the i^{th} carrier voltage, and whether V_{ref} is less than the (n + i)^{th} carrier voltage. If yes, the method 800 proceeds to step 832, and the i^{th} variable bᵢ is set to ‘1’. If no, the method 800 proceeds to step 834, and the i^{th} variable bᵢ is set to ‘0’. At step 836, the sum of all variables bᵢ are summed as b.

At step 840, the sum of variables a and b is obtained, indicated here as C. Then, evaluations are made at steps 850, 860, and 870 based on the values for a, b, and C.

At step 850, if the value of a = i, then the method 800 moves to step 852. At step 852, state vectors corresponding to positive voltage level i, based on the stored energy within the capacitors, are activated, as per Table 10 and/or Table 12. At step 860, if the value of b = i, then the method 800 moves to step 862. At step 862, state vectors corresponding to negative voltage level i, based on the stored energy within the capacitors, are activated, as per Table 10 and/or Table 12. At step 870, if the value of C = 0, then the method moves to step 872. At step 872, state vectors corresponding to zero voltage levels, based on the stored energy within the capacitors, are activated, as per Table 10 and/or Table 12. The method then ends at 880.

Depending on the number of voltage levels produced by the collection 750, different values for the parameter n are considered. For instance, for a five-level PUC, the parameter n = 2; for a nine-level PUC, the parameter n = 3. Other embodiments are also considered.

The sub-modules 752 must be sorted in terms of summation of their measured voltage in order that those have greater energy should be discharged and those have less energy should be charged. It should be understood that the method 800 is carried out for each arm or branch of PUC-MMC 700. In other words, three reference voltage for three phase are selected and the carriers must be planned based on following formula for a five-level PUC-MMC:

$$Δ Φ = \frac{2 π}{2 n}$$

where ΔΦ is the phase shift for carrier signals and n is the number of cells of five-level PUC sub-modules 752 in each arm of the PUC-MMC 700.

In some embodiments, generating 2n + 1 voltage level in a multilevel inverter requires 2n carrier signals in order to modulate one reference signal. For instance, for two sub-modules 752 of five-level PUC, four carriers are used. In another example, for four sub-modules 752 in each arm, eight carrier signals are used to modulate one reference signal.

To generate a maximum voltage level, all sub-modules 752 should be operated in state 1 according to Table 10 for five-level PUC, or Table 12 for nine-level PUC. It should be noted that MMC-PUC 700 with N cells in each arm generates 4N + 1 voltage levels on its phase voltage. In fact, 2N + 1 voltage levels are generated in each arm and 4N + 1 voltage levels is generated across the load of each phase and (2(4N + 1) -1) = 8N + 1 voltage levels is produced across the line voltage. To generate the 4N^{th} voltage level, the module having the highest energy (i.e., the highest-sorted module as per step 808) should be selected to operate in states 2 or 3 in Table 10 to discharge the related capacitor. The methodology described in Table 10 can be used for selection between mentioned states. In some cases, one or more other sub-modules 752 operate in State 1. Additionally, to generate State 4N-1, the sub-modules 752 corresponding to the arrays of I (1), I (2) have to be selected to operate in states 2 or 3 depends on normalized voltages as Table 10. This method is performed on the other voltage levels.

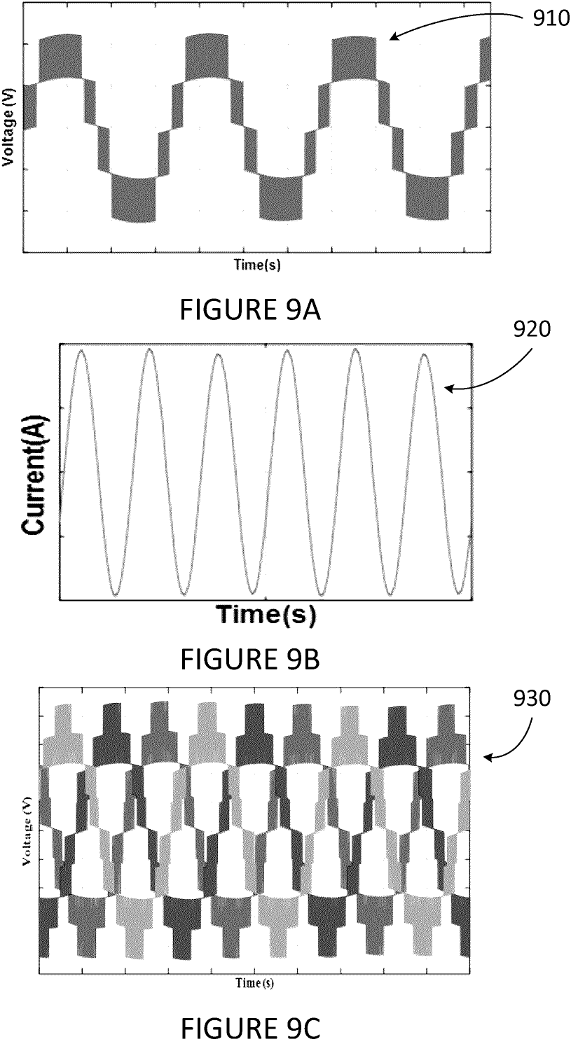

With reference to FIGS. 9A-C, simulation results for the double-star topology 200 and for the PUC-MMC 700 are illustrated. In FIG. 9A, the phase voltage 910 at the output to one of the loads 220 and/or to the grid 230 is illustrated. In FIG. 9B, the output current 920 at the output to one of the loads 220 and/or to the grid 230 is illustrated. As can be seen, the phase voltage 910 and output current 920 substantially resemble AC signals.

In FIG. 9C, a three-phase output voltage 930 of the PUC-MMC 700 to the load 720 is illustrated. As can be seen, the output voltage 930 is indicative of a three-phase AC signal.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A power converter for transforming electrical power between direct current (DC) power and alternating current (AC) power, comprising:
a first set of packed U-cell converters connectable between a first common connection point and a first terminal of an external circuit, the first common connection point connecting to a first terminal of a DC circuit element;
a second set of packed U-cell converters connectable between a second common connection point and a second, opposite terminal of the external circuit, the second common connection point connecting to a second, opposite terminal of the DC circuit element; and
a controller configured for controlling operation of the first and second sets of packed U-cell converters.

2. The power converter of claim 1, wherein the first and second sets of packed U-cell converters each comprise three packed U-cell converters, and wherein, when the external circuit is a three-phase load and the DC circuit element is a DC source, the controller is configured for controlling the operation of the first and second sets of packed U-cell converters to transform DC power produced by the DC source into AC power delivered to the three-phase load.

3. The power converter of claim 2, wherein the controller controlling the operation of the first and second sets of packed U-cell converters to transform DC power produced by the DC source into AC power delivered to the three-phase load comprises causing the first and second sets of packed U-cell converters to operate with at least one redundant state to produce the AC power, wherein the AC power has 2ⁿ + 1 phase voltage levels, where n is the number of capacitors in each packed U-cell converter.

4. The power converter of claim 2, wherein the controller controlling the operation of the first and second sets of packed U-cell converters to transform DC power produced by the DC source into AC power delivered to the three-phase load comprises causing the first and second sets of packed U-cell converters to operate in a plurality of non-redundant states to produce the AC power, wherein the AC power has 2⁽ⁿ⁺¹⁾ - 1 phase voltage levels where n is the number of capacitors in each packed U-cell converter.

5. The power converter of claim 1, wherein the first and second sets of packed U-cell converters each comprise three packed U-cell converters, and wherein, when the external circuit is a three-phase AC source and the DC circuit element is a load, the controller is configured for controlling the operation of the first and second sets of packed U-cell converters to transform AC power produced by the three-phase AC source into DC power delivered to the load.

6. The power converter of claim 1, wherein each packed U-cell converter of the first and second set of packed U-cell converters comprises:
a half-bridge connecting to a first terminal of the packed U-cell converter, the half-bridge comprising a first pair of switches and a first capacitor coupled therebetween; and
a switching cell coupled to the half-bridge and connecting to a second terminal of the packed U-cell converter, the switching cell comprising first and second branches comprising respective first and second groups of switches, and at least one flying capacitor connecting the first and second branches.

7. The power converter of claim 6, wherein the switching cell is extendible to including a plurality of flying capacitors connecting the first and second branches, each flying capacitor coupled to the first and second branches between respective pairs of switches of the first and second groups of switches.

8. The power converter of claim 1, wherein the controller comprises:
a pulse-width modulator configured for obtaining a modulation index and at least one carrier signal and for producing a plurality of voltage levels; and
a voltage balancer coupled to the pulse-width modulator and configured for receiving the plurality of voltage levels and for controlling the operation of the first and second sets of packed U-cell converters based thereon.

9. The power converter of claim 8, wherein the voltage balancer is further configured for controlling the operation of the first and second sets of packed U-cell converters to produce positive-polarity current across the first and second terminals of the external circuit.

10. The power converter of claim 1, wherein the first set of packed U-cell converters comprises a first collection of submodules and wherein the second set of packed U-cell converters comprises a second collection of submodules, each submodule of the first and second collections comprising a packed U-cell converter, and wherein the controller being configured for controlling the operation of the first and second sets of packed U-cell converters comprises the controller being configured for controlling operation of the first and second collections of submodules.

11. The power converter of claim 10, wherein the first and second collection of submodules each comprise a plurality of parallel branches each comprising at least one submodule arranged in series.

12. The power converter of claim 10, wherein the controller being configured for controlling the first and second collections of submodules comprises determining an amount of energy stored in capacitors of the submodules of the first and second collections of submodules and controlling the operation of the first and second collections of submodules based on the amount of energy.

13. The power converter of claim 12, wherein the controller is further configured for determining a direction of current flow through at least one of the first and the second collections of submodules, wherein controlling the operation of the first and second collections of submodules is further based on the direction of current flow.

14. The power converter of claim 13, wherein determining a direction of current flow through at least one of the first and the second collections of submodules comprises sorting the capacitors of the submodules based on a stored energy value for the capacitors.

15. A controller for an electrical power converter for transforming electrical power between direct current (DC) power and alternating current (AC) power, comprising:
a pulse-width modulator configured for
obtaining a modulation index and at least one carrier signal; and
producing a plurality of voltage levels based on the modulation index and the at least one carrier signal; and
a voltage balancer coupled to the pulse-width modulator and configured for:
obtaining the plurality of voltage levels from the pulse-width modulator; and
controlling charging states of capacitors of first and second sets of packed U-cell converters of the electrical power converter based on the plurality of voltage level to operate the electrical power converter.

16. The controller of claim 15, wherein the voltage balancer is further configured for controlling operation of the first and second sets of packed U-cell converters to cause the electrical power converter to produce positive-polarity current.

17. The controller of claim 15, wherein the voltage balancer being configured for controlling the charging states of the capacitors of the first and second sets of packed U-cell converters of the electrical power converter comprises controlling the capacitors to operate with at least one redundant state.

18. The controller of claim 15, wherein the voltage balancer being configured for controlling the charging states of the capacitors of the first and second sets of packed U-cell converters of the electrical power converter comprises controlling the capacitors to operate in a plurality of non-redundant states.

19. The controller of claim 15, further comprising a plurality of sensors for measuring actual voltage levels of the capacitors of the first and second sets of packed U-cell converters of the electrical power converter.

20. The controller of claim 15, wherein the pulse-width modulator is a phase-shift pulse-width modulator.
